(19) United States
(12) Patent Application Publication
(10) Pub. No.: US 2016/0168911 A1
(43) Pub. Date: Jun. 16, 2016

(54) AUTOMATIC ROTATING CONTROL DEVICE OILING SYSTEM

(71) Applicant: HALLIBURTON ENERGY SERVICES, INC., Houston, TX (US)

(72) Inventor: Joseph Michael Karigan, Carrollton, TX (US)

(21) Appl. No.: 14/907,007

(22) PCT Filed: Oct. 25, 2013
(86) PCT No.: PCT/US13/66921

§ 371 Date: Jan. 22, 2016

(51) Int. Cl. E21B 4/00; F16N 13/02

(52) U.S. Cl. CPC E21B 4/003; F16N 13/02

(57) ABSTRACT

A rotating control device (RCD) can include an automatic RCD oiling system for providing lubricating oil to the RCD and preventing wellbore fluid under wellbore pressure from entering the RCD. The automatic RCD oiling system can include an oil pressure intensifier, a pump, and a pump flow controller. The oil pressure intensifier can include a piston assembly for maintaining a pressure differential between pressure from the lubricating oil on a rod side of the piston assembly and an annulus pressure corresponding to a wellbore pressure on the piston side of the piston assembly. The pump can pump lubricating oil from tank into passages to a bearing assembly of the RCD and a pump flow controller that controllably directs lubricating oil to the piston assembly and a return passage to the tank or the pump.

### TECHNICAL FIELD

The present disclosure relates generally to assemblies for use with a wellbore and, more particularly (although not necessarily exclusively), to an automatic oiling system for a rotating control device (RCD) of a wellbore.

### BACKGROUND

Managed pressure drilling and underbalanced drilling can use surface pressure at a wellhead to either overbalance or underbalance a well. This can involve sealing a wellbore at the surface during drilling. A rotating control device (RCD), located on the top of a surface blowout preventer stack (i.e., a “BOP stack”), can be used to seal the wellbore at the surface around a drill pipe using a bearing assembly that includes bearings and seals. Oil can be applied to the bearing assembly of the RCD to preserve the bearings and seals of the bearing assembly.

### BRIEF DESCRIPTION OF THE DRAWINGS

FIG. 1 is an elevation view of a representative well system that can include an automatic rotating control device (RCD) oiling system according to one aspect.

FIG. 2 is a partial schematic view of an automatic RCD oiling system and an RCD according to one aspect.

FIG. 3 is a cross-sectional side view of a pump flow controller of an automatic RCD oiling system according to one aspect.

FIG. 4 is a cross-sectional side view of a pump flow controller of an automatic RCD oiling system according to another aspect.

FIG. 5 is a cross-sectional top view of an oil pump of an automatic RCD oiling system according to one aspect.

### DETAILED DESCRIPTION

Certain aspects and features relate to an automatic rotating control device (RCD) oiling system usable with a wellbore. An oiling system for an RCD can be used to provide lubricating oil, or any type of lubrication fluid, to preserve the bearings and seals in a bearing assembly of the RCD. In some aspects, a small overpressure of the oil pressure versus the annulus pressure corresponding to wellbore pressure can be maintained to prevent ingress of wellbore fluids into the RCD. The amount of pressurization used can vary with the annulus pressure. In one aspect, the automatic RCD oiling system can maintain the pressure of the oil applied to the bearing assembly as the annulus pressure increases or decreases, and can provide additional oil, as needed, to accommodate oil leakage.

In some aspects, the automatic RCD oiling system can include an oil pressure intensifier, a pump, and a pump flow controller that may control the pump flow. The intensifier can include a hydraulic cylinder and a piston assembly that has a piston and a rod, with wellbore communication on a piston side and oil on a rod side. The intensifier may control the oil pressure passively by simple pressure balance. In other aspects, a spring may be used to provide a pre-charge of pressure to the oil system.

The pump may be built into the RCD or may be an external item. In some aspects, energy from a rotating drill pipe can be transferred into the RCD through an element or a kelly driver. The transferred energy can be used to drive the pump, such as by causing a lobe of the pump to rotate. The pump may be a piston-type pump, or another pump type, including vane, gerotor, or gear.

The pump flow controller can use the movement of the piston assembly of the intensifier to open or close a return passage back to the pump or an oil tank. In another aspect, the movement of the piston assembly is mechanically tied to a hydraulic valve component that can open or close the return passage back to the pump or the tank.

The lubricating oil may be forced into the rod side of the piston assembly of the intensifier when the return passage is closed. The volume of oil on the rod side of the piston assembly may accumulate to a specific level. The specific level of oil on the rod side may correspond to a desired pressure differential between the oil on the rod side of the piston assembly and the annular pressure of the wellbore. When the desired pressure differential is reached, the return path to the pump or the tank may be opened. Whether the return passage is open or closed, the oil can flow to the bearing assembly to lubricate the bearing assembly. In some aspects, the oil flow to the bearing assembly may increase when the return passage is closed. In other aspects, the pump flow controller can be integral with the piston assembly of the intensifier.

These illustrative aspects and examples are given to introduce the reader to the general subject matter discussed here and are not intended to limit the scope of the disclosed concepts. The following sections describe various additional features and examples with reference to the drawings in which like numerals indicate like elements, and directional descriptions are used to describe the illustrative aspects but, like the illustrative aspects, should not be used to limit the present disclosure.

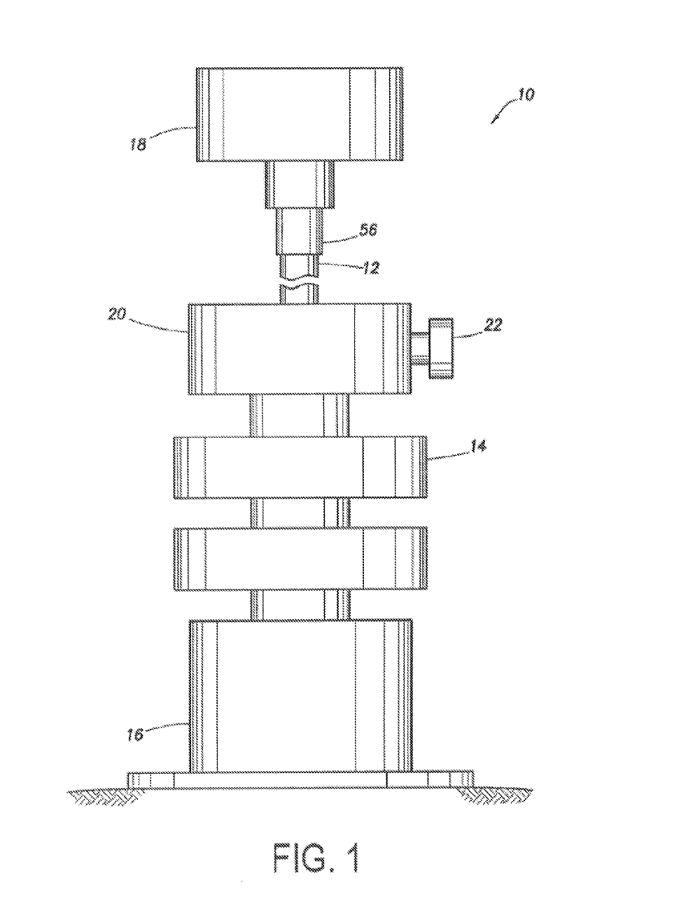

FIG. 1 is an elevation view of an example of a well system 10 that can include an automatic RCD oiling system according to one aspect. The well system 10 includes a drill pipe 12 that extends through a blowout preventer (BOP) stack 14 on a wellhead 16. The drill pipe 12 may include one or more bottom hole assemblies, such as measurement while drilling assemblies, bits, and reamers. In other aspects, the drill pipe 12 is replaced with one or more other types of tubing elements. A top drive 18 (including, for example, a hydraulic or electric motor) can be used to rotate the drill pipe 12 to cause rotation of a drill bit (not shown) at a far end of the drill pipe 12 for drilling into the earth. In other aspects, the drill pipe 12 is rotated with a kelly and rotary table or with a mud motor.

An RCD 20 can seal off an annulus formed radially about the drill pipe 12, for example, to isolate the well below the wellhead 16 from the atmosphere. An outlet 22 can allow for circulation of fluid (such as drilling mud) through the well below the RCD 20. The RCD 20 can include a bearing assembly with sealing elements and bearings for sealing off the annulus. The RCD 20 can also include an automatic RCD oiling system that can provide lubricating fluid, such as oil, to the bearing assembly.

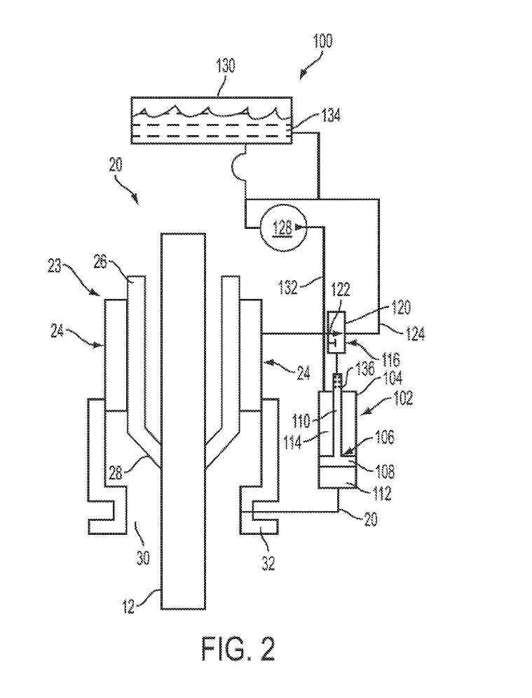

FIG. 2 is a partial schematic view of an automatic RCD oiling system 100 with the RCD 20 about the drill pipe 12 according to one aspect. The RCD 20 has a bearing assembly 23 that includes a bearing set 24 coupled to a rotating sealing element 26 that can contact and surround the drill pipe 12. The bearing set 24 may include dynamic seals. Coupled to the rotating sealing element 26 is a rotating mandrel 28. The bearing set 24 can allow the rotating sealing element 26 and the rotating mandrel 28 to rotate about the drill pipe 12 to seal off an annulus 30 between the drill pipe 12 and a body 32 of the RCD 20. Pressure in the annulus 30 may correspond to wellbore pressure from a wellbore.

Lubricating oil can be provided to the bearing set 24 by the automatic oiling system 100, which can also provide the lubricating oil for preventing the ingress of wellbore fluids at wellbore pressure into the RCD 20. The automatic oiling system 100 includes an oil pressure intensifier 102, a pump 128, and a pump flow controller 116.

The oil pressure intensifier 102 includes a hydraulic cylinder 104 with a piston assembly 106. The piston assembly 106 includes a piston 108 coupled to a rod 110. The rod 110 extends from a rod side 114 of the piston 108. The piston side 112 of the piston assembly 106 may be in fluid communication with pressure in the annulus 30 that corresponds to wellbore pressure. The annulus pressure can act on the piston side 112 of the piston assembly 106. For example, the annulus pressure can exert a force on the piston 108 of the piston assembly 106 in a direction toward the rod side 114 of the piston assembly 106. The force from the annulus pressure can cause the piston 108 to move toward the rod side 114 of the piston assembly 106 unless the piston assembly 106 includes a pressure for balancing the magnitude of the force from the annulus pressure. Oil 134, which can be lubricating oil for the bearing assembly 23, from a tank 130 can be pumped by the pump 128 to provide pressure on the rod side 114 of the piston assembly 106 for balancing the force from the annulus pressure and prevent ingress of the annulus pressure into the RCD 20. The level at which pressure from the oil 134 balances the force from the annulus pressure can be based on a size of the piston 108 and the rod 110. For example, the oil pressure used to balance the annulus pressure may equal the annulus pressure multiplied by a ratio that is the piston area divided by the difference of the rod area from the piston area. As the annulus pressure decreases, the pump flow controller 116 can reduce of volume of oil on the rod side 114. As the annulus pressure increases, the pump flow controller 116 can cause the volume of oil on the rod side 114 to increase.

The oil 134 from the tank 130 can be pumped by the pump 128 through a flow passage 132 from the tank 130 to the rod side 114 of the piston assembly 106. The oil 134 located on the rod side 114 can exert a pressure on the rod side 114 of the piston assembly 106. The pressure from the volume of oil can act on the rod side 114 of the piston assembly 106. For example, the pressure from the volume of oil can exert a force on the piston 108 of the piston assembly 106 in a direction toward the piston side 112 of the piston assembly 106. The force from pressure from the oil can cause the piston 108 to oppose the force from the annulus pressure acting on the piston side 112 of the piston assembly 106.

The pump flow controller 116 includes a hydraulic valve component 120, which can be controlled by the piston assembly 106. In other aspects, the pump flow controller 116 can be another suitable mechanical control device. The hydraulic valve component 120 can be in an open or a closed position, depending on the location of the rod 110 of the piston assembly 106. When in the open or partially open position, the hydraulic valve component 120 may align a path 122 with a return passage 124 back to the pump 128 or back to the tank 130. When the hydraulic valve component 120 is in the closed position, the return passage 124 is closed and the oil 134 is pumped by the pump 128 through the flow passage 132 into the rod side 114 of the piston assembly 106. The oil can flow to the bearing set 24 of the bearing assembly 23 whether the return passage 124 is open or closed so that lubricating oil can be delivered for the bearing set 24. The pump flow controller 116 according to other aspects may be integral to the rod 110 of the piston assembly 106.

In some aspects, the pump 128 is coupled to and driven by the rotation of the rotating mandrel 28. The rotating mandrel 28 can be coupled to and moved by the rotational motion of the drill pipe 12. In other aspects, the pump 128 is powered by an external drive connected directly to the drill pipe 12, or other suitable pump mechanisms. The pump 128 can receive the oil 134 from the tank 130 and pump the oil 134 to the bearing set 24 of a bearing assembly 23. The pump 128 may also pump oil into the rod side 114 of the piston assembly 106, or through the return passage 124 back to the pump 128 or the tank 130, depending on the status of the hydraulic valve component 120. In another aspect, a variable displacement pump can be used to modulate how much flow is needed.

The piston 108 can move against the annulus pressure at the wellbore pressure as the volume or pressure of the oil 134 on the rod side 114 of the piston assembly 106 increases. The pressure on the rod side 114 of the piston assembly 106 can be slightly higher than the pressure on the piston side 112 corresponding to the wellbore pressure due to the reduced area of the piston 108 on the rod side 114 (e.g., due to the diameter of the rod 110). The oil pressure intensifier 102 can include a spring 136 or other additional offset pressure source to add an additional offset of the pressure difference between the piston side 112 and the rod side 114 of the piston assembly 106. For example, a compressed gas can be used in a linked piston section for generating a force to offset the pressure difference in addition, or alternative, to the spring 136. In other aspects, the oil pressure intensifier 102 does not include a spring or other additional offset pressure source.

The rod 110 can move to a position that opens the hydraulic valve component 120 when the volume of the oil 134 on the rod side 114 reaches a pre-set optimal amount. The hydraulic valve component 120 can open and allow the oil 134 to flow through the return passage 124 back to the pump 128 or back to the tank 130. The optimal amount of the oil 134 on the rod side 114 can correspond to a desired pressure differential between the pressure in the annulus 30 and the oil pressure on the rod side 114 of the piston assembly 106.

For example, the pump 128 can continuously pump the oil 134 from the tank 130 through the system, until a sufficient volume of oil 134 is on the rod side 114 of the piston assembly 106. The hydraulic valve component 120 can open if the oil 134 on the rod side 114 of the piston assembly 106 reaches a sufficient volume. The oil 134 may flow through return passage 124 back to the pump 128 or the tank 130 when the hydraulic valve component 120 is open, instead of flowing through the flow passage 132 into the rod side 114 of the piston assembly 106. The volume of the oil 134 on the rod side 114 can decrease. For example, the oil 134 may leak at the seals of the bearing set 24 of a bearing assembly 23. The piston 108 can move towards the rod side 114 of the piston assembly 106 in response to the decrease in the oil 134 volume of oil 134 on the rod side 114. The movement of the piston assembly 106 can cause the rod 110 to be positioned such that the hydraulic valve component 120 can be closed. The closed hydraulic valve component 120 can close, block or otherwise obstruct the return passage 124. The pumped oil 134 can flow through flow passage 132 and into the rod side 114 of the piston assembly 106 when the return passage 124 is closed. The optimal volume of the oil 134 on the rod side 114 of the piston assembly 106 may be based on the desired pressure differential between the pressure from the annulus 30 at the piston side 112 and the pressure at the rod side 114.

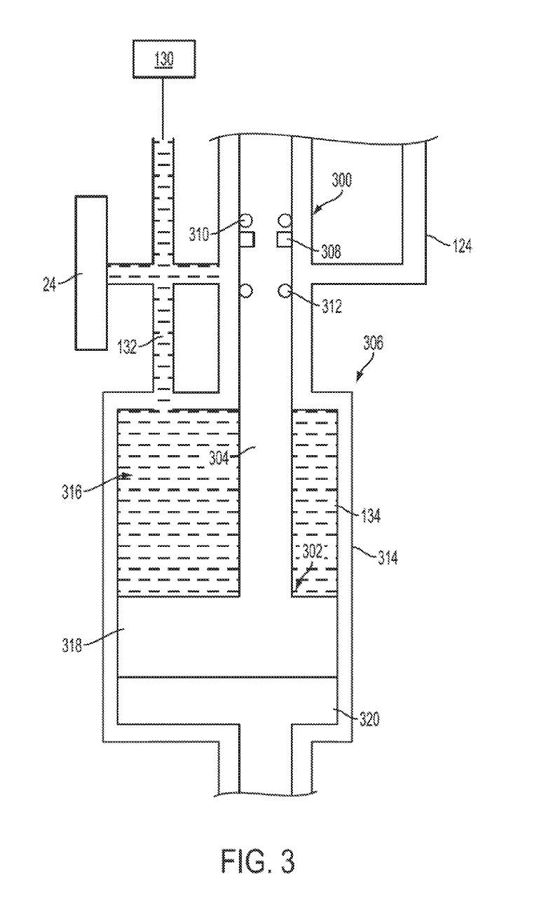

FIG. 3 is a cross-sectional side view of a pump flow controller 300 of an automatic RCD oiling system according to one aspect. In one aspect, the pump flow controller 300 is integral to a piston assembly 302 of an oil pressure intensifier 306. The pump flow controller 300 may be integral to a rod 304 of the piston assembly 302 and can include a penetrating groove 308 located between a first seal 310 and a second seal 312. The groove 308 may be a hole, slot, notch, or any type of passage.

The rod 304 can be positioned such that the groove 308 is above the return passage 124 and the second seal 312 is below the return passage 124 when the volume of the oil 134 located on a rod side 316 of the piston assembly 302 is below an optimal amount. The groove 308 positioned above the return passage 124 can allow the return passage 124 to be closed or blocked by the rod 304. Oil 134 can flow through the flow passage 132 and into the rod side 316 of the piston assembly 302 when the return passage 124 is closed or blocked by the rod 304. The oil 134 can be pumped to the bearing set 24 of a bearing assembly whether the return passage 124 is open or closed. In some aspects, more oil 134 may be pumped to the bearing set 24 when the return passage 124 is closed than when it is open.

The oil 134 may be pumped through the flow passage 132 and into the rod side 316 of the piston assembly 302. The increasing volume of oil 134 on the rod side 316 can move a piston 318 of the piston assembly 302 against the annulus pressure and towards a piston side 320 of the hydraulic cylinder 104. The rod 304 can be positioned such that the groove 308 in the rod 304 is aligned with the return passage 124 such that the return passage is open or partially open as the pressure increases. The groove 308 can be positioned to align with the return passage 124 when there is a sufficient volume of the oil 134 on the rod side 316. The pumped oil 134 can flow through the return passage 124 back to the pump 128 or a tank when the groove 308 is aligned with the return passage 124. In some aspects, the pumped oil 134 can flow to a lower pressure area, which may be the tank.

There may be a pressure differential between the pressure on the piston side 320 and the pressure of the oil 134 on the rod side 316 of the piston assembly 302. This pressure differential may determine the amount of oil 134 on the rod side 316 of the piston assembly 302 sufficient to position the piston assembly 302 such that the groove 308 is aligned with the return passage 124. In this aspect, oil 134 can flow to the bearing set 24 of an assembly regardless of whether the return passage 124 is open or closed.

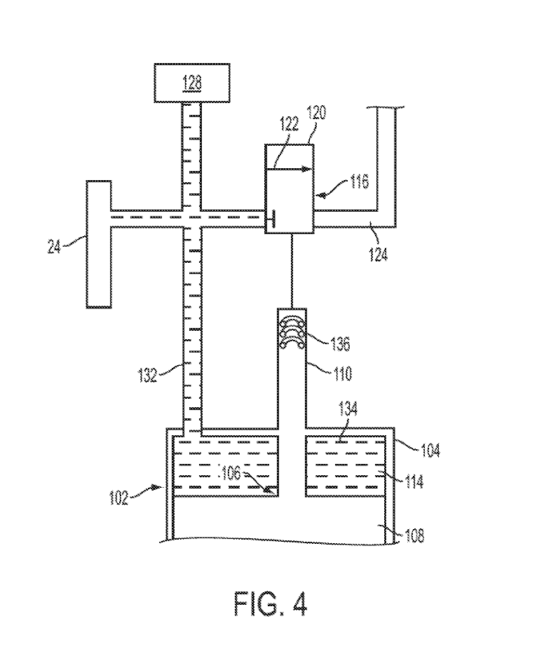

In another aspect shown in FIG. 4, the pump flow controller 116 includes the hydraulic valve component 120 that is mechanically coupled to the piston assembly 106 of the oil pressure intensifier 102. The hydraulic valve component 120 can be in the closed position due to the position of the piston assembly 106 within the hydraulic cylinder 104 of the oil pressure intensifier 102. The position of the piston assembly 106 can be determined by the amount of oil 134 on the rod side 114 of the piston assembly 106 (and optionally an additional offset pressure from the spring 136 or other additional offset pressure source) versus the pressure on a piston side of the piston assembly 106.

The oil 134 from the pump 128 can flow through a flow passage 132 into the rod side 114 of the piston assembly 106. The oil 134 may flow through the flow passage 132 into the rod side 114 of the piston assembly 106 when the hydraulic valve component 120 is in the closed position (as shown in FIG. 4). The piston 108 can move towards the piston side of the piston assembly 106 as the volume of oil 134 on the rod side 114 of the piston assembly 106 increases. The position of the rod 110 can also cause the hydraulic valve component 120 to open by a path 122 of the hydraulic valve component 120 aligning with the return passage 124 to the pump 128 or the tank. In some aspects, oil 134 can flow to a lower pressure area, such as the tank, when the hydraulic valve component 120 opens. The volume of oil 134 that may cause the hydraulic valve component 120 to open may be determined based on a desired pressure differential between the pressure on a piston side and the pressure of the oil 134 on the rod side 114 of the piston assembly 106.

For example, the pressure differential between the pressure at the annulus of the wellbore and the pressure on the rod side 114 of the piston assembly 106 can determine the location of the piston assembly 106 within the hydraulic cylinder 104. The hydraulic valve component 120 can respond to the location of the piston assembly 106 by opening (partially or fully) or closing. The oil 134 can flow through flow passage 132 into the rod side 114 of the piston assembly 106 when the hydraulic valve component 120 is closed and blocking the return passage 124. The oil 134 may flow to the bearing set 24 of a bearing assembly of the RCD whether the return passage 124 is open or closed.

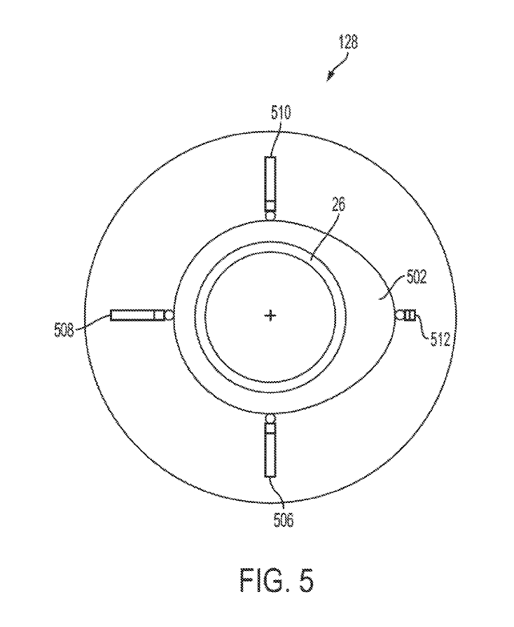

FIG. 5 is a cross-sectional top view of the oil pump 128 of the automatic RCD oiling system 100 of FIG. 2 according to one aspect. The oil pump 128 can be built into the RCD. In other aspects, the oil pump 128 may be an external item. The oil pump 128 may assist in replacing oil loss, for example, due to a bearing set seal leakage. The oil pump 128 may include an eccentric section 502 that provides the drive for the pump 128. The eccentric section 502 may be single lobed, as shown in FIG. 5, or may include multiple lobes. The eccentric section 502 may be connected to an RCD body with bolts and threaded onto the rotating mandrel 28, or coupled by another mechanism. In other aspect, the eccentric section 502 may be integral to the pump 128 assembly.

The oil pump 128 may include pistons 506, 508, 510, 512, located concentrically around the eccentric section 502. Although four pistons are shown, any number of pistons, including one piston, can be used. The eccentric section 502 can rotate as the rotating mandrel 28 of the RCD 20 in FIG. 2 rotates from rotation of the drill pipe 12 to drive the pump 128. A lobe of the eccentric section 502 can contact a piston. FIG. 5 depicts one example of the eccentric section 502 contacting piston 512. The piston 512 can be compressed by the eccentric section 502 and cause oil to be pumped out of the pump 128. In other aspects, the tank 130 may be pressurized by compressed gas or another mechanism to assist the pump 128 suction supply. Furthermore, alternative pump types may be utilized, including but not limited to vane, gerotor, or a gear pump, instead of the piston-type pump 128 depicted in FIG. 5.

The pump 128 may operate continuously. In another aspect, the pump 128 may not operate continuously but instead operation of the pump 128 may be manually controlled at desired intervals of time. For example, a user may manually turn the pump 128 on once a day for a desired time period. In another aspect, a computing device communicatively coupled to the pump 128 via transmission wires or wireless link may turn the pump 128 on and off at desired intervals. The computing device may include a processor device that can execute code stored on a non-transitory computer-readable medium. Examples of the computing device include a personal computer, a server device, a laptop, a smart phone, and a tablet device.

The pump 128 may be activated at various intervals to increase the oil on a rod side of a piston assembly of an intensifier. The amount of oil on the rod side of the piston assembly can cause a piston of the piston assembly to move towards a piston end of a hydraulic cylinder. An increase in annulus pressure can move the piston towards the rod side of the hydraulic cylinder when the pump 128 is not pumping. An increase in the oil pressure applied to a bearing assembly of an RCD may correspond to an increase in the volume of the oil on the rod side of the piston assembly.

The volume of oil on the rod side of the piston assembly may increase until the pressure differential between the oil pressure applied to the bearing assembly and the annulus pressure is balanced. The oil applied to the bearing assembly may leak out of the bearing assembly. The piston of the intensifier may move towards the rod side of the piston assembly as the oil leaks out of the bearing assembly. The piston may move towards the rod end until the piston is at the rod end of the hydraulic cylinder. The pump 128 can pump oil from a tank into the rod side of the piston assembly by a pump flow controller. As the oil flows into the rod side, the piston may move away from the rod end of the hydraulic cylinder.

In one aspect, an RCD may include an oil pressure intensifier with a piston assembly that has a piston and a rod for maintaining a pressure differential between the oil in the RCD and the annulus pressure by a pump and a pump flow controller. The pump may be positioned in a first passage between a tank and a bearing assembly. The first passage may be for oil flow from the tank. The pump flow controller may be positioned between the first passage and a return passage. The return path may direct oil flow back to the tank.

In another aspect, an RCD oiling assembly may include a pump that receives oil from a tank. The RCD may also include an oil pressure intensifier that includes a piston assembly that has a piston and a rod for maintaining a pressure differential between the rod side of the piston assembly and the piston side of the piston assembly by the pump and a pump flow controller. The pump may be positioned in a first passage. The first passage may direct oil flow from the tank into the oil pressure intensifier. The pump flow controller may be positioned between the first passage and a return passage. The return passage may direct oil flow back to the pump or the tank.

In another aspect, a method of automatically oiling an RCD is provided. Oil from an atmospheric tank is automatically pumped through a first passage into a rod side of a piston assembly of an oil pressure intensifier. The pressure differential between the oil on the rod side of the piston assembly and the annulus pressure is automatically monitored. A return path through a pump flow controller back to the pump or the tank is automatically opened when the pressure differential between the oil on the rod side of the piston assembly and the annulus pressure is at or above an optimal level. The return path through the pump flow controller is automatically closed when the pressure differential between the oil on the rod side of the piston assembly and the annulus pressure is below the optimal level. The optimal level can be based on a size of the piston assembly.

The foregoing description of certain aspects, including illustrated aspects, has been presented only for the purpose of illustration and description and is not intended to be exhaustive or to limit the disclosure to the precise forms disclosed. Numerous modifications, adaptations, and uses thereof will be apparent to those skilled in the art without departing from the scope of the disclosure.

1. A rotating control device (RCD) assembly, comprising:
an oil pressure intensifier that includes a piston assembly positioned within a cylinder, the piston assembly including a piston coupled to a rod for maintaining a pressure differential between lubricating oil for a bearing assembly in the RCD acting on a rod side of the piston assembly and an annulus pressure corresponding to a wellbore pressure acting on a piston side of the piston assembly, by a pump and a pump flow controller;
the pump positioned with respect to a first passage between a tank and the bearing assembly, wherein the first passage is for oil flow from the tank to the rod side of the piston assembly and the bearing assembly; and
the pump flow controller positioned between the first passage and a return passage for directing the oil through the first passage or the return passage, wherein the return passage is for oil flow from the first passage to the pump or the tank.

2. The RCD assembly of claim 1, wherein the pump flow controller is integral to the rod, the pump flow controller including a passage and at least one seal.

3. The RCD assembly of claim 2, wherein the rod is moveable in response to the pressure differential between the oil in the RCD and the annulus pressure such that the passage aligns with the return passage.

4. The RCD assembly of claim 1, wherein the pump flow controller is a hydraulic valve component that includes an open position, a closed position, and intermediate positions that are partially open.

5. The RCD assembly of claim 4, wherein the hydraulic valve component is moveable in response to the pressure differential between the RCD and the annulus pressure such that the hydraulic valve component opens and allows the oil to flow through the return passage.

6. The RCD assembly of claim 1, wherein the pump is a variable displacement pump configured for modulating flow.

7. The RCD assembly of claim 1, wherein the pump is coupled to and powered by motion of a rotating mandrel of the bearing assembly in response to rotation of a drill pipe sealed by the RCD.

8. The RCD assembly of claim 7, wherein the pump is a piston-type pump that includes an eccentric section including at least one lobe,
wherein the eccentric section is coupled to the rotating mandrel of the bearing assembly.

9. An automatic rotating control device (RCD) oiling assembly, comprising:
a pump for receiving oil from a tank;
an oil pressure intensifier that includes a piston assembly that has a piston and a rod for maintaining a pressure differential between the rod side of the piston assembly and the piston side of the piston assembly by the pump and a pump flow controller,
wherein the pump is positioned between the tank and the oil pressure intensifier in a first passage for directing the oil from the tank into the oil pressure intensifier,
wherein the pump flow controller is positioned between the first passage and a return passage for allowing oil flow back to the pump or the tank.

10. The automatic RCD oiling assembly of claim 9, wherein the pump flow controller is responsive to the pressure differential between the rod side and the piston side of the piston assembly being below a level set by a size of the piston assembly by closing the return passage,
wherein the pump flow controller is responsive to the pressure differential between the rod side and the piston side of the piston assembly at or above the level by opening the return passage

11. The automatic RCD oiling assembly of claim 9, wherein the pump further comprises:
an eccentric section including at least one lobe;
at least one piston located concentrically around the eccentric section,
wherein the eccentric section is coupled to movement of a drill pipe.

12. The automatic RCD oiling assembly of claim 9, wherein the pump flow controller is integral to the rod of the piston assembly, the pump flow controller including a passage through the rod, a first seal above the passage, and a second seal below the passage.

13. The automatic RCD oiling assembly of claim 9, wherein the pump flow controller is a hydraulic valve component that is mechanically coupled to movement of the rod of the piston assembly.

14. The automatic RCD oiling assembly of claim 9, wherein the oil pressure intensifier includes an additional offset pressure source for adding an additional offset of the pressure differential between the piston side and the rod side.

15. The automatic RCD oiling assembly of claim 14, wherein the additional offset pressure source is a spring.

16. A method of automatically oiling a rotating control device (RCD) comprising:
pumping oil with a pump from an atmospheric tank through a first passage into a rod side of a piston assembly of an oil pressure intensifier; and
automatically responding, by a pump flow controller, to a pressure differential between the rod side of the piston assembly and an annulus pressure corresponding to a wellbore pressure on a piston side of the piston assembly by opening or closing a return path for oil to flow back to a tank.

17. The method of claim 16, further comprising:
pumping the oil through the first passage to a bearing assembly of the RCD when the return path is both open and closed.

18. The method of claim 16, further comprising:
opening the return path through the pump flow controller by aligning a passage in the rod of the piston assembly with the return path.

19. The method of claim 18, further comprising:
aligning the passage in the rod of the piston assembly with the return path based on a location of a piston of the piston assembly within a hydraulic cylinder of the oil pressure intensifier,
wherein the location of the piston is determined by the pressure differential between the oil on the rod side of the piston assembly and the annulus pressure on the piston side of the piston assembly.

20. The method of claim 16, further comprising:
opening the return path through the pump flow controller by opening a hydraulic valve component, wherein the hydraulic valve component is mechanically coupled to the piston assembly.
